(19) United States
(12) Patent Application Publication
(10) Pub. No.: US 2021/0354501 A1
(43) Pub. Date: Nov. 18, 2021

(54) CARRIER FOR TRANSFERRING OBJECTS

(71) Applicant: CaseNode Technology Service CO., LTD., Kaohsiung City (TW)

(72) Inventor: Shu-Fen Lin, Kaohsiung City (TW)

(21) Appl. No.: 17/076,821

(22) Filed: Oct. 22, 2020

(30) Foreign Application Priority Data
May 13, 2020 (TW) 109115945

(51) Int. Cl. B44C 1/17; A44C 15/00

(52) U.S. Cl. CPC B44C 1/1741; A44C 15/0005

(57) ABSTRACT

A carrier for transferring objects is provided. The carrier includes a flexible body having a first surface, a second surface, a plurality of transfer parts and an initial rolling area. The second surface is opposite to the first surface, the plurality of transfer parts are provided between the first surface and the second surface and the initial rolling area is located on an edge portion of the flexible body. A plurality of decoration objects are respectively disposed in the accommodating space of the plurality of transfer parts. Pressure is exerted on each transfer part by rolling up the flexible body from the edge portion of the initial rolling area and pressing on a press portion when the flexible body is flatly disposed on an external carrier, such that each decoration object is detached from the corresponding transfer part and attached to the external carrier.

### BACKGROUND OF THE INVENTION

### 1. Field of the Invention

The present disclosure relates to a carrier for transferring objects, and more particularly to a carrier for transferring decorative items.

### 2. Description of the Prior Art

Nowadays, a wearable decorative accessory is typically attached to a wire or chain passing therethrough so that a user can wear the decorative accessory by tying or hanging the wire or chain on their body. Alternatively, a plurality of decorative accessories can be set on, welded to, or adhesively bonded to a piece of fabric, a metal base, or a fixture to form a clothing accessory that can be attached to clothes or worn on a specific body part. Or, the aforesaid wired or chained clothing accessories can be fastened to a carrier such as a mobile phone or a handbag. As to tiny decorative items, it is common practice to arrange a plurality of them in a patterned configuration and fix them to a supporting member such as a metal base, a threading wire, a chain, or a piece of fabric so that the resulting assembly can be worn in any of the ways stated above. Such assemblies, however, tend to be quite limited in terms of visual or esthetic effect. Another type of decorative accessories features adhesives, and such accessories are made by fixing a patterned arrangement of tiny decorative items to a substrate such as a transparent or opaque film or sticker so that a user can wear the tiny decorative items by attaching the substrate to the skin adhesively. Once adhered to the skin, however, the substrate will cause the skin area to which it is attached to wrinkle to various degrees as the user moves, thus compromising the appearance of the decorative items. Some decorative accessories can be worn in a contour-free manner or dispense with a supporting member, but this requires a plurality of decorative items to be manually, sequentially, and adhesively attached to the body part to be adorned or the object to be decorated (e.g., a mobile phone) in order to form a decorative patterned configuration. The foregoing process, however, is time-consuming and difficult to be modeled, which hinders the formation of geometric or regular array-shaped decorative patterns.

Therefore, there is a need to provide a solution for solving the problems in conventional arts.

### SUMMARY OF THE INVENTION

The present invention provides a carrier for transferring decorative items, with a view to removing the prior art limitations on the ways in which decorative items can be worn and assembled. The carrier of the invention can be used to attach decorative items to an external carrier, making it feasible and convenient to wear decorative items in a patterned configuration.

In one aspect, the present disclosure provides a carrier for transferring objects, including a flexible body having a first surface, a second surface, a plurality of transfer parts, and an initial rolling area, wherein the second surface is opposite the first surface, the plurality of transfer parts are provided between the first surface and the second surface, and the initial rolling area is located on an edge portion of the flexible body, each of the transfer parts having a first opening, a second opening, and an accommodating space, wherein the first opening is formed in the first surface, a press portion is formed at the first opening, the second opening is formed in the second surface, a stop portion is formed at the second opening, and the accommodating space is formed between the press portion and the stop portion; wherein a plurality of decoration objects are disposed in the accommodating spaces of the transfer parts respectively, and each of the decoration objects is exposed through the second opening of a corresponding transfer part; and wherein pressure is exerted on each of the transfer parts by rolling up the flexible body from an edge portion of the initial rolling area and pressing on each of the press portions when the second surface of the flexible body is flatly disposed on an external carrier, such that each of the decoration objects is detached from the corresponding transfer part and attached to the external carrier.

In the present disclosure, the initial rolling area has an abutment area at the first surface.

In another aspect, the present disclosure further provides a rolling and pressing member provided on the abutment area.

In the present disclosure, the rolling and pressing member comprises a coupling portion and a shaft portion, and the shaft portion is fixedly provided on the flexible body via the coupling portion.

In the present disclosure, the coupling portion comprises at least one ear-shaped loop, at least one clamping element, at least one threading wire, at least one rivet, or adhesive.

In the present disclosure, in each of the transfer part, the press portion includes a flat portion formed along an edge of the first opening or includes a flat portion that covers the first opening partially or completely, and the stop portion includes a protruding portion protruding toward an inner side of the second opening.

The present disclosure further includes a positioning member removably provided on the first opening of the transfer parts to help secure the decoration objects in the accommodating spaces.

The present disclosure further includes a peelable release film covering a joining element and the second surface of the flexible body.

The present invention provides a carrier having a plurality of transfer parts in a patterned arrangement used to accommodate a plurality of decoration objects. By rolling the rolling and pressing member and by exerting pressure on each transfer part sequentially or simultaneously, the decoration objects are sequentially or simultaneously transferred to the external carrier. As a result, all the decoration objects are attached to the external carrier, such as human skin, a mobile phone casing, or other external carriers, in the present patterned configuration.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram showing a first preferred embodiment of the carrier for transferring objects according to the present invention.

FIG. 1B is a sectional view of the carrier in FIG. 1A, taken along line A-A′.

FIG. 2 is a schematic diagram showing a reverse side of the carrier in FIG. 1A.

FIG. 3A is schematic diagram showing the first preferred embodiment of a transfer part of the carrier in FIG. 1A.

FIG. 3B is schematic diagram showing the transfer part in FIG. 3A from a different viewing angle.

FIG. 3C is schematic diagram showing another preferred embodiment of a transfer part of the carrier for transferring objects according to the present invention.

FIG. 4 is schematic diagram showing another embodiment of the carrier for transferring objects according to the invention.

FIG. 5 is schematic diagram showing the embodiments in FIG. 1 and FIG. 4 being operated.

FIG. 6 is schematic diagram showing a second preferred embodiment of the carrier for transferring objects according to the present invention.

FIG. 7 is schematic diagram showing the embodiment in FIG. 6 being operated.

### DETAILED DESCRIPTION

To illustrate the objectives, technical schemes, and technical effects of the present disclosure more clearly and more defined, the present disclosure will be described in details below by using embodiments in conjunction with the appending drawings. It should be understood that the specific embodiments described herein are merely for explaining the present disclosure, and as used herein, the term “embodiment” refers to an instance, for explaining the present disclosure, and used herein, the term “embodiment” refers to an instance, an example, or an illustration but is not intended to limit the present disclosure. In addition, the articles “a” and “an” as used in the specification and the appended claims should generally be construed to mean “one or more” unless specified otherwise or clear form the context to be directed to a singular form.

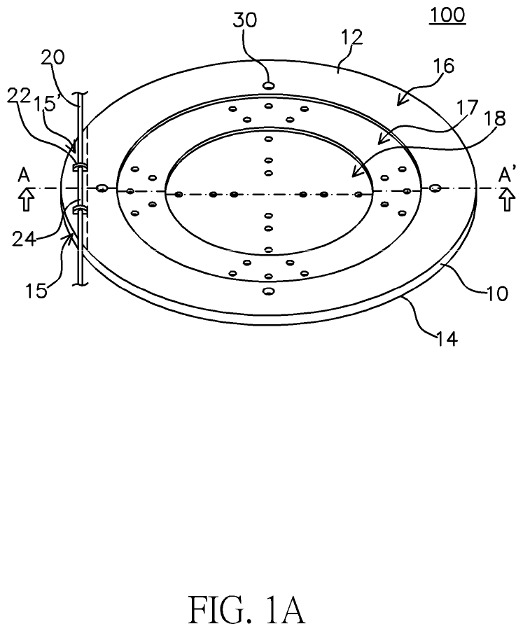

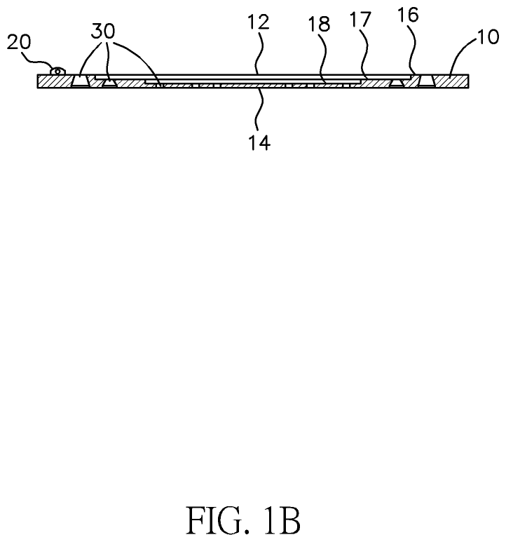

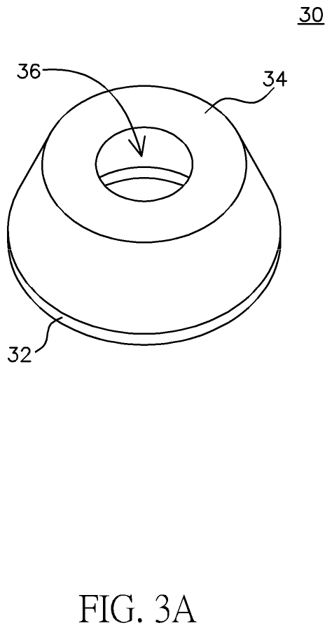

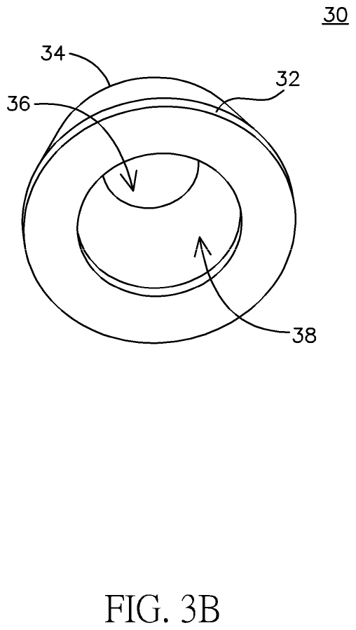

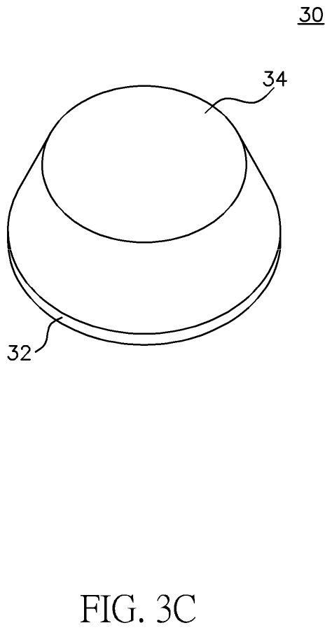

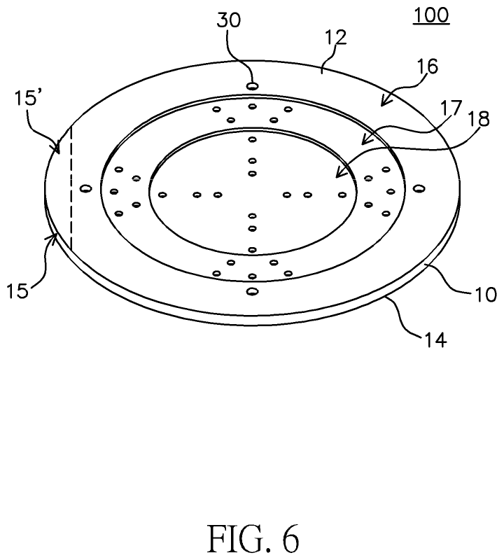

Please refer to FIG. 1A and FIG. 1B. FIG. 1A schematically shows the first preferred embodiment of the carrier for transferring objects according to the present invention. FIG. 1B is a sectional view of the carrier in FIG. 1A, taken along line A-A′. The carrier 100 for transferring objects according to the present invention includes a flexible body 10 and a rolling and pressing member 20. In this embodiment of the present invention, the flexible body 10 is integrally formed of a flexible material that allows the flexible body 10 to be rolled up with ease, such as soft plastic, silicone, paper, metal, or a combination of the above. The flexible body 10 has a first surface 12, a second surface 14 opposite to the first surface 12, and a plurality of transfer parts 30 provided between the first surface 12 and the second surface 14. Each transfer part 30 is provided with a first opening formed in the first surface 12, a second opening formed in the second surface 14, and an accommodating space for accommodating a decoration object. The transfer parts 30 may vary in dimension in order to accommodate decoration objects of different dimensions. The transfer parts 30 are provided in the flexible body 10 in a distributed manner independently from one another, and may be provided at any positions of the flexible body 10. By varying the positions or dimensions of the transfer parts 30, patterned arrangements of different configurations can be formed. The detailed features of the transfer parts 30 will be described further below with reference to FIG. 3A and FIG. 3B. In this embodiment of the present invention, the flat surfaces (or the first surface 12 and the second surface 14) of the flexible body 10 are circular; in other embodiments, the flat surfaces of the flexible body 10 may have a rectangular or other polygonal shape. In this embodiment, the carrier has an edge portion provided with an initial rolling area 15, and the initial rolling area 15 has an abutment area 15′ located at the first surface 12 of the carrier 100. The first surface 12 is divided into three regions 16, 17, and 18. In this embodiment, the initial rolling area 15 is located in the region 16; in other embodiments, the initial rolling area 15 may vary in position, and the region to which the initial rolling area 15 belongs may also vary, depending on the shape of the flexible body 10. That is to say, the position of the initial rolling area 15 is not limited to that illustrated herein. In the first preferred embodiment, in which the rolling and pressing member 20 is provided, the abutment area 15′ is required so that the rolling and pressing member 20 can be fixedly provided on the abutment area 15′. In the second preferred embodiment shown in FIG. 6, the rolling and pressing member 20 is dispensed with, so the abutment area 15′ (which is the region of the initial rolling area that is located at the first surface) remains a flat surface.

In the embodiments illustrated herein of the present invention, the first surface 12 of the flexible body 10 is divided into the three regions 16, 17, and 18, and the dimensions of the transfer parts in each region are different from those in another region. Moreover, each region is provided only with transfer parts of the same dimensions. For example, in the embodiment shown in FIG. 1A, the flexible body 10 is divided into the three regions 16, 17, and 18 in a concentric manner, with the outer region 16 being provided with transfer parts 30 of the largest dimensions (e.g., of the greatest width and depth), and the inner region 18 being provided with transfer parts 30 of the smallest dimensions (e.g., of the smallest width and depth). As the outer region 16 in this embodiment is provided with transfer parts 30 of the largest dimensions, the thickness (i.e., the height between the first surface and the second surface) of the corresponding region of the flexible body is greater than those of the other regions. In other embodiments, the first surface may be divided into two or more than three regions in a concentric manner, or be divided into a plurality of regions in a different manner, such as by parallel division, perpendicular division, or random division; the present invention has no limitation in this regard. In other embodiments, it is also feasible that the flexible body 10 is not divided into any regions at all. While transfer parts of different dimensions can accommodate decoration objects of different dimensions, the fact that the transfer parts 30 and the flexible body 10 are integrally formed and are deformable allows each transfer part 30 to accommodate, within the limit of its expandability, decoration objects whose dimensions fall within a certain range.

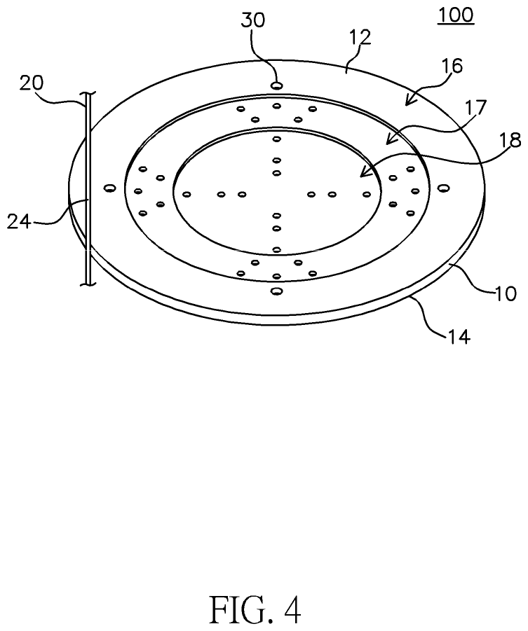

In the embodiment shown in FIG. 1A, the rolling and pressing member 20 of the carrier 100 is fixedly provided on the abutment area 15′ of the first surface 12 of the flexible body 10. The abutment area 15′ is located in an edge region of the first surface 12 of the flexible body 10. In order for the rolling and pressing member 20 to be able to roll up the entire flexible body 10, the abutment area 15′ should be as close to the edge of the first surface 12 as possible. In this embodiment, the rolling and pressing member 20 includes a coupling portion 22 and a shaft portion 24. The shaft portion 24 is fixedly provided on the flexible body 10 via the coupling portion 22. The coupling portion 22 may include one or more ear-shaped loops, clamping elements, threading wires, rivets, or the like. The shaft portion 24 may be a rod with a circular cross section or other slender objects that are suitable for manual operation. In other embodiments, the coupling portion 22 of the rolling and pressing member 20 may be simplified as an adhesive or a sticker with strong adhesion so that the shaft portion 24 is still able to be fixed on the flexible body 10 (as in the embodiment shown in FIG. 4).

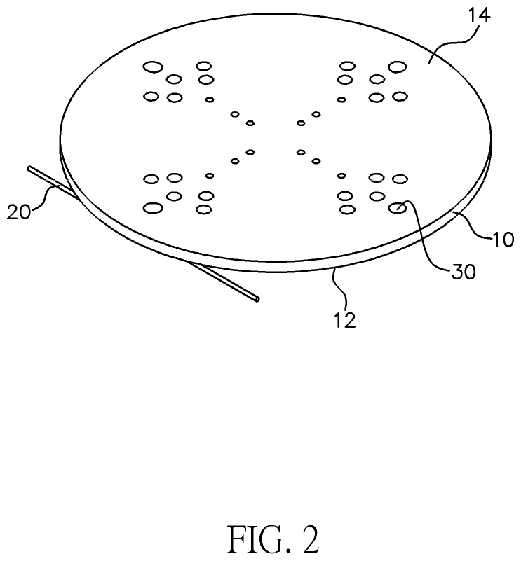

Please refer to FIG. 2. FIG. 2 schematically shows a reverse side of the carrier in FIG. 1A. The second surface 14 of the carrier 100 is a uniform flat surface (except for the openings of the transfer parts 30) in order to be flatly disposed on and thereby attached to the surface of a particular external carrier. Please note that the carrier in the embodiment shown in FIG. 6 has the same reverse side as the carrier in FIG. 2.

Please refer to FIG. 3A and FIG. 3B. FIG. 3A schematically shows the first preferred embodiment of a transfer part of the carrier in FIG. 1A. FIG. 3B shows the transfer part in FIG. 3A from a different viewing angle. It should be pointed out that the transfer part is depicted as having a bowl shape only to facilitate understanding; in fact, the transfer part and the flexible body are integrally formed, meaning the transfer part is a bowl-shaped cavity formed in the thickness of the flexible body. The transfer part 30 according to this embodiment is used to accommodate a decoration object such as a tiny decorative item or accessory, e.g., a rhinestone, a silver decorative item, a pearl, a decorative item made of a metal alloy or plastic, or a tiny wearable functional accessory. The transfer part 30 includes a stop portion 32, a press portion 34, a first opening 36, a second opening 38, and an accommodating space (not indicated in the drawings). The press portion 34 is located at the first opening 36 and is designed as an annular flat surface extending along the edge of the first opening 36. The stop portion 32 is located at the second opening 38 and is designed as an annular protruding portion extending along the edge, and protruding slightly toward the inner side, of the second opening 38. In another embodiment, the press portion 34 may be a circular flat surface that covers the first opening 36 completely (as shown in FIG. 3C). In other embodiments, the press portion 34 may be a crescent or semicircular flat surface that covers the first opening 36 only partially. The stop portion 32 serves to prevent the decoration object in the transfer part 30 from being detached from the transfer part 30 or falling out of the transfer part 30 through the second opening 38 by accident, but will not interfere with the detachment of the decoration object from the transfer part 30 when the carrier 100 is operated with the intention to effect such detachment. The press portion 34 serves not only to prevent the decoration object in the transfer part 30 from being detached from the transfer part 30 or falling out of the transfer part 30 through the first opening 36, but when the carrier 100 is operated, to also transmit pressure to the decoration object, thus helping to detach the decoration object from the transfer part 30. As the transfer part 30 is deformable, the stop portion 32 can expand and contract while the decoration object is being disposed into the transfer part 30, thereby securing the decoration object in place but allowing release of the decoration object when so intended. Similarly, thanks to its deformability, the press portion 34 can transmit pressure to or squeeze the decoration object when subjected to and deformed by an external force.

In this embodiment, the transfer part 30 is similar to a bowl-shaped cavity, and the second opening 38 in the second flat surface 14 is larger than the first opening 36 in the first flat surface 12. The second opening 38 is the entrance/exit area for the decoration object. The second opening 38 must be so dimensioned that a particular decoration object can be put into the accommodating space from the outside but is kept from falling out of the accommodating space easily, and that the stop portion 32 can provide additional support for the decoration object effectively. As to the first opening 36, the smaller its dimensions the better, lest the decoration object fall out of the transfer part 30, and this is why the press portion 34 is formed to reduce the first opening 36. In other embodiments, however, it may be necessary for the first opening 36 to have adequate dimensions so as to be used to position the decoration object. In the foregoing designs, the second opening 38 is usually larger than the first opening 36. Since the transfer part 30 and the flexible body 10 are integrally formed of the same material and are deformable, the first opening 36 in other embodiments may have the same dimensions as the second opening 38, and the aforesaid functions of the transfer part 30 can still be achieved.

In one preferred embodiment, the carrier 100 for transferring objects further includes a positioning member (not shown). The positioning member is removably provided on the first openings 36 of the transfer parts 30 to help secure the decoration objects in their respective accommodating spaces. The positioning member may be, but is not limited to, a peelable sticker or a removable adhesive film. For example, the positioning member is a removable adhesive film and is laid over the first opening 36 of each transfer part 30 in advance so that, once the decoration objects are disposed in the transfer parts 30 respectively, each decoration object has a portion (i.e., the portion adjacent to the first opening 36) adhesively attached to the adhesive film to help secure the decoration object in the corresponding accommodating space. In this embodiment, it is required that each first opening 36 have certain dimensions in order for the adhesive film to adhere to the decoration objects.

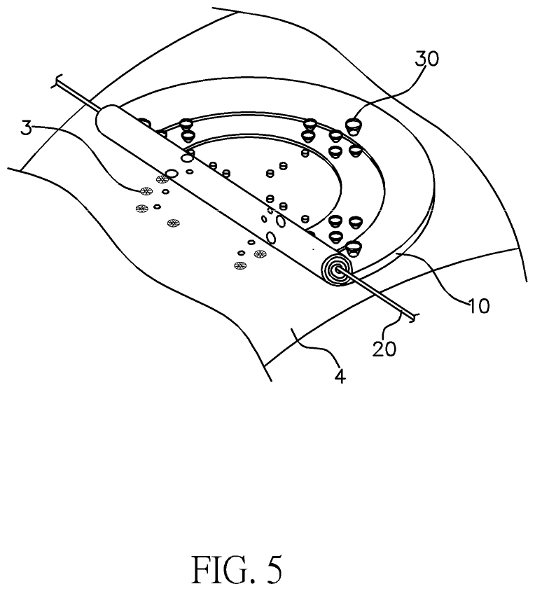

FIG. 5 schematically shows how the embodiments in FIG. 1 and FIG. 4 are operated. The embodiment shown in FIG. 5 uses human skin as an external carrier 4, and yet the external carrier 4 is not limited to human skin. In other embodiments, the external carrier 4 may be a wall surface, a casing, a piece of flannel or fleece, a piece of garment, or the like. To begin with, the second surface 14 of the flexible body 10 of the carrier 100 is disposed compliantly on the external carrier 4. Then, the positioning member (not shown) on the first openings is removed such that the decoration objects are no longer secured in position with respect to the first openings (optionally, the press portions 34 of the transfer parts 30 can be manually pressed before the positioning member is removed, in order to bring the objects 3 in the transfer parts 30 into contact with the external carrier 4), and the flexible body 10 is subsequently rolled with the rolling and pressing member 20 and thereby gradually wound around the rolling and pressing member 20. When the rolling and pressing member 20 is moved over any of the transfer parts 30, the pressure generated by the rolling and pressing member 20 is exerted on the press portion 34 of the transfer part 30, and the press portion 34 is thus squeezed and transmits the pressure to the corresponding object. Now that the transfer parts 30 are deformable, whenever the rolling and pressing member 20 is moved over a transfer part 30, the second opening 38 of the transfer part 30 expands. In the meantime, the decoration object in the transfer part 30 is subjected to the aforesaid pressure, is thereby pushed toward the second opening 38 of the transfer part 30 and gradually become separated from the accommodating space of the transfer part 30, and ends up in contact with and attached to the skin. In one preferred embodiment, the bottom side of each decoration object 3 (i.e., the side facing the second opening or the side to be attached to the skin) is coated with an adhesive, such as a pressure-sensitive adhesive, and the adhesive is used to adhere the decoration objects to the external carrier 4. Please note that the adhesion of the adhesive or the size of the adhesive-coated area should be able to ensure that the bottom portions of the decoration objects have stronger adhesion than the positioning member (which may be a sticker or adhesive) on the first openings 36, thus making it easier for the decoration objects to be detached from their respective transfer parts 30 and be attached to the external carrier 4. Pressure-sensitive adhesives generally have a release film as their outer layer, so before disposing the flexible body 10 on the external carrier 4, it is necessary to peel off the release film that covers the second surface of the flexible body 10, in order to expose the adhesive on the bottom portions of the decoration objects. By rolling the rolling and pressing member 20 over the transfer parts 30, the decoration objects 3 are sequentially or simultaneously detached from their respective transfer parts 30 and securely attached to the external carrier 4. Meanwhile, the flexible body 10 is gradually wound around the rolling and pressing member 20 and moved away from the external carrier 4 (or the skin). During the process, the operator can look into the exposed transfer parts 30 wound around the rolling and pressing member 20 and check if the decoration objects 3 in those transfer parts 30 have all been transferred to the skin. Should certain decoration objects 3 remain in their respective transfer parts 30, the rolling and pressing member 20 can be rolled in the reverse direction so that the transfer parts 30 still holding their respective decoration objects 3 are brought back to their previous positions on the skin. The rolling and pressing member 20 can then be rolled forward over those transfer parts 30 again to exert pressure on the decoration objects 3 therein so that the decoration objects 3 are detached from their respective transfer parts 30 and attached to the skin. When moved back and forth over certain transfer parts 30, the rolling and pressing member pushes the corresponding decoration objects further toward the second openings 38 of those transfer parts 30, ensuring that the corresponding decoration objects 3 are attached to the skin without affecting the position of the remaining portion of the flexible body 10 on the skin. By rolling the flexible body 10 gradually with the rolling and pressing member 20 and by exerting pressure on the press portion 34 of each transfer part 30 in a back-and-forth manner if necessary, all the transfer parts 30 are moved away from the skin and wound around the rolling and pressing member 20, and the decoration 3 are sequentially or simultaneously detached from their respective transfer parts 30, attached to the skin, and thus transferred to the skin as a whole in their intended configuration.

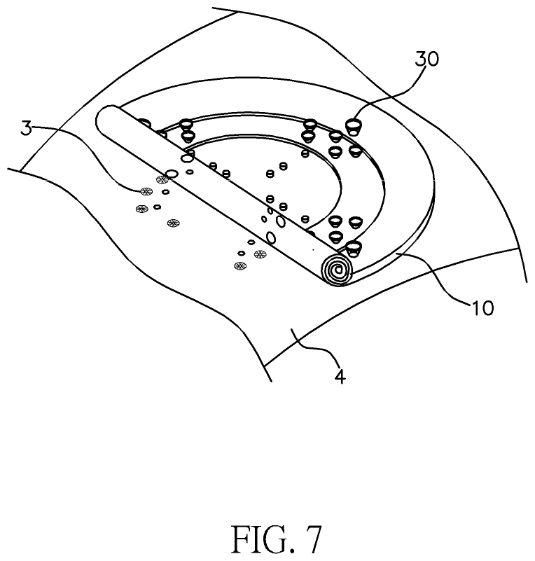

Please refer to FIG. 7. FIG. 7 schematically shows how the embodiment in FIG. 6 is operated. The embodiment shown in FIG. 7 uses human skin as the external carrier 4, but the external carrier 4 is not limited to human skin. In addition, the carrier 100 in this embodiment dispenses with the rolling and pressing member 20. To start with, the second surface 14 of the flexible body 10 is disposed flatly on the external carrier 4, and a downward pressure is exerted on each press portion 34 by hand such that each transfer part 30 and the decoration object therein are subjected to the pressure. Each decoration object is pushed toward the second opening 38 of the corresponding transfer part 30 by the pressure and is therefore gradually and partially separated from the accommodating space of the corresponding transfer part 30 and brought into contact with the external carrier 4. An edge portion of the initial rolling area 15 of the flexible body 10 is then pulled up and rolled over as the starting point from which the flexible body 10 is rolled. As the flexible body 10 is rolled and thereby exerts pressure on the press portions 34 being rolled, the affected transfer parts 30 are sequentially or simultaneously moved away from the external carrier 4. During the process, the decoration objects 3 in the affected transfer parts 30 are also sequentially or simultaneously detached from the transfer parts 30 and attached to the external carrier 4. As a result, all the decoration objects are attached to the external carrier 4 in the preset patterned configuration.

The carrier disclosed herein for transferring objects has a plurality of transfer parts for securing and releasing decoration objects, and is also provided with operating elements (such as the initial rolling area and the rolling and pressing member) that allow the flexible body to be rolled against each press portion as a fulcrum. Once the flexible body is disposed flatly on an external carrier, the carrier of the present invention can be rolled up by hand or with the rolling and pressing member so as to exert pressure on the objects to be transferred. The flexible body generates a torque while being moved away from the external carrier such that the upward pulling force acting on each decoration object is counteracted by the downward pressure transmitted to the decoration object through the corresponding press portion. This allows each decoration object to be securely attached to the external carrier while only the flexible body is moved away from the external carrier. Thus, the intended function of transferring objects that are arranged in a patterned configuration in the flexible body to an external carrier is achieved. The rolling and pressing member can also be moved back and forth over any transfer part to exert pressure on the corresponding press portion repeatedly, ensuring that all the decoration objects are detached from their respective transfer part and transferred to the external carrier. A user or consumer can operate the carrier of the present invention by themselves without the assistance of an additional tool and thereby easily attach a plurality of tiny decorative accessories to their body, a mobile phone casing, or other external carriers in various patterned designs.

The examples described above are only some preferred embodiments of the principles of the present invention. It should be understood that the setup and details stated herein can obviously be modified and altered. The present invention, therefore, is intended to be defined by the following claims rather than be limited by the specific details given in the description and explanation of the examples provided herein.

Those skilled in the art will readily observe that numerous modifications and alterations of the device and method may be made while retaining the teachings of the invention. Accordingly, the above disclosure should be construed as limited only by the metes and bounds of the appended claims.

1. A carrier for transferring objects, comprising:
a flexible body having a first surface, a second surface, a plurality of transfer parts, and an initial rolling area, wherein the second surface is opposite to the first surface, the plurality of transfer parts are provided between the first surface and the second surface, and the initial rolling area is located on an edge portion of the flexible body;
each of the transfer parts having a first opening, a second opening, and an accommodating space, wherein the first opening is formed in the first surface, a press portion is formed at the first opening, the second opening is formed in the second surface, a stop portion is formed at the second opening, and the accommodating space is formed between the press portion and the stop portion;
wherein a plurality of decoration objects are disposed in the accommodating spaces of the transfer parts, and each of the decoration objects is exposed through the second opening of the corresponding transfer part; and
wherein pressure is exerted on each of the transfer parts by rolling up the flexible body from an edge portion of the initial rolling area and pressing on each of the press portions when the second surface of the flexible body is flatly disposed on an external carrier, such that each of the decoration objects is detached from the corresponding transfer part and attached to the external carrier.

2. The carrier for transferring objects as claimed in claim 1, wherein the initial rolling area has an abutment area at the first surface.

3. The carrier for transferring objects as claimed in claim 2, further comprising a rolling and pressing member provided on the abutment area.

4. The carrier for transferring objects as claimed in claim 3, wherein the rolling and pressing member comprises a coupling portion and a shaft portion, and the shaft portion is fixedly provided on the flexible body via the coupling portion.

5. The carrier for transferring objects as claimed in claim 4, wherein the coupling portion comprises at least one ear-shaped loop, at least one clamping element, at least one threading wire, at least one rivet, or adhesive.

6. The carrier for transferring objects as claimed in claim 1, wherein in each of the transfer parts, the press portion comprises a flat portion formed along an edge of the first opening or comprises a flat portion that covers the first opening partially, and the stop portion comprises a protruding portion protruding toward an inner side of second opening.

7. The carrier for transferring objects as claimed in claim 1, wherein the transfer parts are provided in the flexible body in a distributed manner independently from one another.

8. The carrier for transferring objects as claimed in claim 1, further comprising a positioning member removably provided on the first openings of the transfer parts to help secure the decoration objects in the accommodating spaces respectively.

9. The carrier for transferring objects as claimed in claim 1, further comprising a joining element provided on a bottom portion of each of the decoration objects to help attach the decoration objects to the external carrier.

10. The carrier for transferring objects as claimed in claim 9, further comprising a peelable release film covering the joining elements and the second surface of the flexible body.

11. A carrier for transferring objects, comprising:
a flexible body having a first surface, a second surface, a plurality of transfer parts, and an initial rolling area, wherein the second surface is opposite to the first surface, the plurality of transfer parts are provided between the first surface and the second surface, and the initial rolling area is located on an edge portion of the flexible body;
each of the transfer parts having a press portion, an opening, and an accommodating space, wherein the press portion is formed in the first surface, the opening is formed in the second surface, a stop portion is formed at the opening, and the accommodating space is formed between the press portion and the stop portion;
wherein a plurality of decoration objects are disposed in the accommodating spaces of the transfer parts, and each of the decoration objects is exposed through the opening of the corresponding transfer part; and
wherein pressure is exerted on each of the transfer parts by rolling up the flexible body from an edge portion of the initial rolling area and pressing on each of the press portions when the second surface of the flexible body is flatly disposed on an external carrier, such that each of the decoration objects is detached from the corresponding transfer part and attached to the external carrier.
